(19) United States
(12) Patent Application Publication
(10) Pub. No.: US 2014/0368419 A1
(43) Pub. Date: Dec. 18, 2014

(54) BACKLIGHT DRIVING MODULE AND LIQUID CRYSTAL DISPLAY USING THE SAME

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: JIE-SONG ZHOU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/951,402

(22) Filed: Jul. 25, 2013

(30) Foreign Application Priority Data
Jun. 13, 2013 (CN) 201310233283X

(51) Int. Cl. G09G 3/36; H05B 33/08

(52) U.S. Cl. CPC G09G 3/3648; H05B 33/0809
USPC 345/102; 315/287

(57) ABSTRACT

A liquid crystal display (LCD) includes a backlight driving module. The backlight driving module includes a boost circuit, a control chip, and a ferrite bead. The boost circuit includes a metal-oxide-semiconductor-field-effect transistor (MOSFET). The control chip includes a pulse width modulation (PWM) input pin and provides PWM signals to turn on and turn off the MOSFET. One end of the ferrite bead is connected to the PWM input pin, and another end is connected to the gate of the MOSFET.

### BACKGROUND

1. Technical Field

The present disclosure relates to liquid crystal display (LCD) technology, and particularly to a backlight driving module and an LCD having the same.

2. Description of Related Art

A backlight module of many LCDs includes a number of light emitting diodes (LEDs) connected in series. The voltage applied to the backlight module is 60V-150V. However, the input voltage is usually 24V. Thus, a backlight driving module is employed to increase the input voltage. A known backlight driving module 100 is shown in FIG. 2. The module 100 includes a control chip 11 and a boost circuit 12. The control chip 11 provides high frequency pulse width modulation (PWM) signals to turn a metal-oxide-semiconductor-field-effect transistor (MOSFET) 122 of the boost circuit 12 on and off, so that the boost circuit 12 increases the input voltage. However, the control chip 11 can generate high frequency noise which can be magnified by the boost circuit 12. The magnified high frequency noise may adversely affect the performance of the LCD.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding portions throughout the several views.

FIG. 1 is a circuit diagram of a backlight driving module, in accordance with an exemplary embodiment.

FIG. 2 is a circuit diagram of a known backlight driving module.

### DETAILED DESCRIPTION

Embodiments of the present disclosure are now described, with reference to the accompanying drawings.

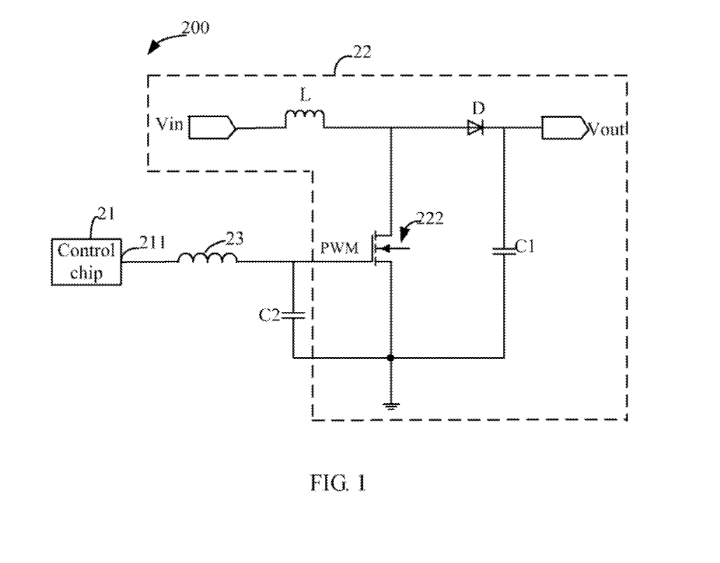

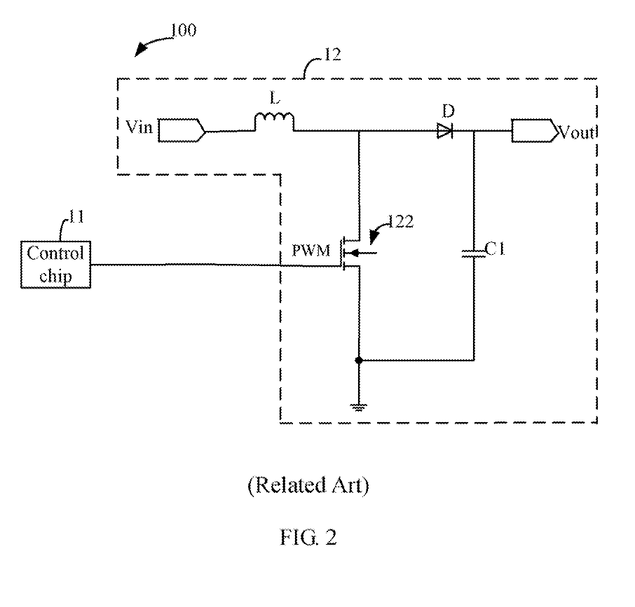

Referring to FIG. 1, an embodiment of a backlight driving module 200 is illustrated. The module 200 includes a control chip 21, a boost circuit 22, a ferrite bead 23, and a capacitor C2. The ferrite bead 23 and the capacitor C2 are arranged between the control chip 21 and the boost circuit 22. The boost circuit 22 is the same as the boost circuit 12 shown in FIG. 2, and will not be described in detail in this embodiment. The control chip 21 provides PWM signals to turn a MOSFET 222 on and off. One end of the ferrite bead 23 is connected to a PWM signal input pin 211 of the control chip 21, and another end is connected to one end of the capacitor C2 and the gate of the MOSFET 222. Another end of the capacitor C2 is grounded.

In this embodiment, the ferrite bead 23 can absorb a great part of high frequency noise generated by the control chip 21, and the remaining part of the high frequency noise can be conducted to ground via the capacitor C2.

In this embodiment, the control chip 21 is nearer to the ferrite bead 23 and the capacitor C2 than the boost circuit 22, thus the ferrite bead 23 can better absorb the high frequency noise.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A backlight driving module comprising:
a boost circuit comprising a metal-oxide-semiconductor-field-effect transistor (MOSFET);
a control chip comprising a pulse width modulation (PWM) input pin and providing PWM signals to turn on and turn off the MOSFET; and
a ferrite bead with one end connected to the PWM input pin and another end connected to the gate of the MOSFET.

2. The backlight driving module as described in claim 1, further comprising a capacitor with one end connected between the ferrite bead and the gate of the MOSFET and another end grounded.

3. The backlight driving module as described in claim 2, wherein the control chip is nearer to the ferrite bead and the capacitor than the boost circuit.

4. A liquid crystal display (LCD) comprising:
a backlight driving module comprising:
a boost circuit comprising a metal-oxide-semiconductor-field-effect transistor (MOSFET);
a control chip comprising a pulse width modulation (PWM) input pin and providing PWM signals to turn on and turn off the MOSFET; and
a ferrite bead with one end connected to the PWM input pin and another end connected to the gate of the MOSFET.

5. The LCD as described in claim 4, wherein the backlight driving module further comprises a capacitor with one end connected between the ferrite bead and the gate of the MOSFET and another end grounded.

6. The LCD as described in claim 5, wherein the control chip is nearer to the ferrite bead and the capacitor than the boost circuit.
